(19) United States
(12) Patent Application Publication
(10) Pub. No.: US 2022/0406219 A1
(43) Pub. Date: Dec. 22, 2022

(54) INTERFACE FOR VISUALLY IMPAIRED

(71) Applicant: GESTURES UP LTD, Yavne (IL)

(72) Inventors: Eyar Shtabinski, Yavne (IL); Ido Marko, Netanya (IL); Ronen Aharon Chen, Givatayim (IL)

(21) Appl. No.: 17/840,625

(22) Filed: Jun. 15, 2022

(30) Foreign Application Priority Data
Jun. 20, 2021 (GB) 2108845.5

(51) Int. Cl. G09B 21/00; G06F 3/0485; G06F 3/0488; G06F 3/16

(52) U.S. Cl. CPC G09B 21/006; G06F 3/0485; G06F 3/0488; G06F 3/167

(57) ABSTRACT

A user interface for a visually impaired user of a mobile computer system. A touch interface is enabled on a touch screen and an audio interface is enabled on a loudspeaker and a microphone. Remotely stored content is previously ordered in a list or tree. The previously ordered remotely stored content is accessible to the visually impaired person by playing the content on the loudspeaker using multiple inputs including a touch gesture on the touch screen and a speech input into the microphone. In accordance with the inputs, an order is changed of navigating the content within a list for a future use of the user interface

### BACKGROUND

### 1. Technical Field

The present invention relates to an interface for mobile computer systems and more specifically a touch and audio interface for visually impaired persons.

### 2. Description of Related Art

Mobile electronic devices such as tablet computers and smart phones have become essential for business, social interactions and acquisition of information. Mobile electronic devices provide user-friendly touch interfaces for users with normal sight. However, such devices are typically difficult, if not impossible to use by visually impaired users. In addition to not being able to see text and other icons that are present on the screen of such devices, text input using a touch screen keyboard is difficult or impossible for vision impaired users. Today, many visually impaired people avoid regular use of the Internet, and those who do try to access the Internet using currently available interfaces have great difficulty.

Thus, there is a need for and it would be advantageous to have an improved interface for a conventional smart phone for use by visually impaired persons.

### BRIEF SUMMARY

Various methods, mobile computer systems, and/ or user interfaces are disclosed herein for use be a visually impaired person. The mobile computer system includes a touch screen, a loudspeaker and a microphone. A user interface is provided including a touch interface enabled on the touch screen and an audio interface enabled on the loudspeaker and the microphone. Remotely stored content is previously ordered in a list or tree. The previously ordered remotely stored content is accessible to the visually impaired person by playing the content on the loudspeaker using multiple inputs including a touch gesture on the touch screen and a speech input into the microphone. In accordance with the inputs, an order is changed of navigating the content within a list for a future use of the user interface.

The input may include a first input of directional swipe on the touch screen from a user. The directional swipe may be either upward, downward, leftward or rightward anywhere on the touch screen. The input may include a second input of a long press on the touch screen. The second input of a long press may initiate and maintain the microphone operational for an audio input for the duration of the long press. The input may include a third input of a tap or double tap. The third input of the tap or double tap may open a context dependent previously defined set of options. The visually impaired user may input anywhere on the touch screen: a first input of a directional swipe selectably either upward, downward, leftward or rightward, a second input of a long press on the touch screen for press to talk and, a third input of the tap or double tap to open a context dependent previously defined set of options. The first input, the second input, the third input and the audio input are collectively configured to perform all of: navigating through previously order content, reading content, composing text, editing text and playing audio.

Various non-transitory computer-readable-media are disclosed herein having software instructions stored therein to perform various methods as disclosed herein.

### BRIEF DESCRIPTION OF THE DRAWINGS

The invention is herein described, by way of example only, with reference to the accompanying drawings, wherein:

FIG. 1 illustrates a simplified block diagram of mobile computer system, according to features of the present invention;

FIG. 2, illustrates the mobile computer system and touch screen thereof, according to features of the present invention; and

FIG. 3 illustrates a flow diagram of a method, according to an embodiment of the present invention.

The foregoing and/or other aspects will become apparent from the following detailed description when considered in conjunction with the accompanying drawing figures.

### DETAILED DESCRIPTION

Reference will now be made in detail to features of the present invention, examples of which are illustrated in the accompanying drawings, wherein like reference numerals refer to like elements throughout. The features are described below to explain the present invention by referring to the figures.

Before explaining features of the invention in detail, it is to be understood that the invention is not limited in its application to the details of design and the arrangement of the components set forth in the following description or illustrated in the drawings. The invention is capable of other features or of being practiced or carried out in various ways. Also, it is to be understood that the phraseology and terminology employed herein is for the purpose of description and should not be regarded as limiting.

By way of introduction, various embodiments of the present invention are directed to a user interface for a mobile computer system which includes innovative tools for controlling access to content and performing online transactions by a visually impaired user. The user interface may include a virtual personal assistant and has ability to navigate through and control presentation of content, e.g. remotely stored at a Web site host. According to an embodiment of the present invention, an application programming interface (API) may be provided to a Web site manager which enables accessibility to content stored on a Web site to visually impaired individuals.

Features of the present invention enable the visually impaired person to browse the Internet, perform actions and transactions and consume content in a way similar to a visually competent person, thus providing access to content which to date has been inaccessible to the visually impaired and elderly population.

According to features of the present invention a client application is provided on a mobile computer system, e.g. smartphone, which may receive both audio, i.e. speech inputs and touch gestures on a touch screen. The user interface and client application enables operations including: content navigation, reading of texts including control of the reading, e.g. repeat, skip, reading speed control; composing and editing text; and control of consumption of audio/video content; all without requiring use of visible icons on the display of the smartphone. Natural language processing may be used to process speech inputs, questions and/or commands.

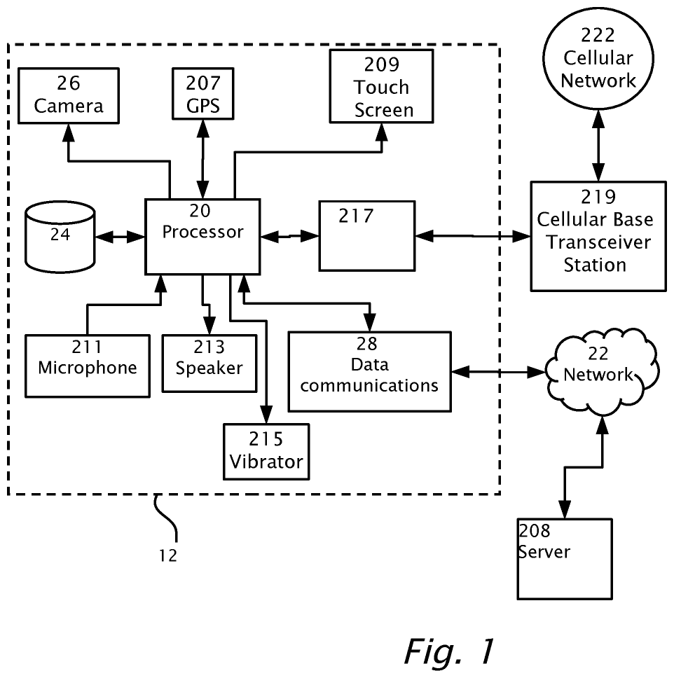

Referring now to the drawings, reference is now made to FIG. 1 which illustrates a simplified block diagram of mobile computer system 12 according to features of the present invention. Mobile computer system 12 is connectable over a data network 22 to a server 208. Mobile computer system 12 is also connectable through a cellular base station transceiver 219 to the remainder of cellular network 222. Mobile computer system 12 includes a processor 20 connected to local data storage 24. A data communications module 28 connects processor 20 to data network 22. A cellular communications module 217 connects processor 20 to cellular network 222. Mobile computer system 12 may include connected to processor 20, peripheral accessory devices such as a touch screen/display 209, global positioning system (GPS) 207, camera 26, a microphone 211, a speaker 213, a vibrator 215, accelerometer/gravity sensor, gyroscopic sensor, Blue-tooth™, infra-red sensor (not shown).

Mobile computer system 12 may be for example an iPhone™ of Apple Inc., or a smart-phone configured to run an Android™ open operating system or a tablet such as iPad™ or a tablet running on an Android™ operating system.

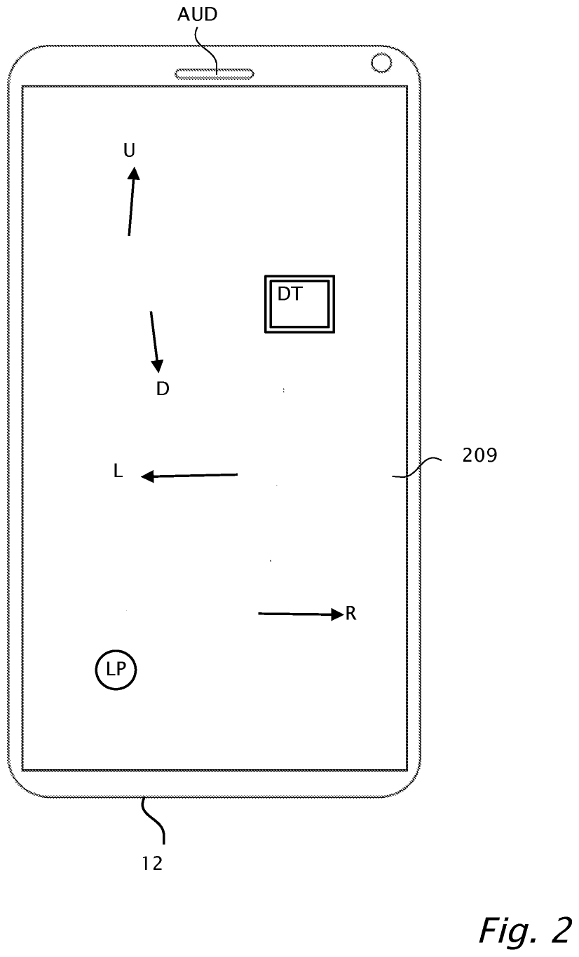

Reference is now made to FIG. 2, which illustrates mobile computer system 12 and touch screen 209 thereof, according to features of the present invention. Touch gestures are schematically illustrated which may be performed anywhere on touch screen 209. Four swipe gestures are illustrated by arrows, which are distinguishable by general direction on the two dimensional touch screen 209. A visually impaired person is generally able to orient smartphone 12 by locating the power and/or volume button. Upward in the plane of touch screen 209 on smartphone 12 is generally toward the edge of touch screen near audio output AUD. Arrows marked with letters U,L,R and D show respectively a general direction of an upward U swipe, leftward L swipe, rightward R swipe and downward D swipe. The four swipe gestures U,L,R and D may be used for manual content navigation, by way of example.

Another touch input is a long press and hold which may be performed anywhere on touch screen 209, shown schematically on touch screen 209 as circle labeled with LP. A long press and hold may be used to activate and maintain an audio input, e.g. a question to a virtual personal assistant. Long press and hold may be configured as a press to talk (PTT) feature which signals processor 20 to maintain microphone 211 active only during the duration of the long press and hold; and processor 20, i.e. virtual personal assistant does not attempt to interpret background noises.

Other available touch inputs may be a tap or double tap, shown schematically in FIG. 2 as a double rectangle labeled with DT. As all touch inputs and gestures, a tap or double tap is accepted anywhere on touch screen 209. A double tap is analogous to a double click on an icon of a display screen and depending on context opens a set of tools or actions selected by the user

According to a feature of the present invention, the client application may audio output a question to a user and a yes/no response is requested which may be responded to by the user by a left swipe/right swipe respectively.

According to a feature of the present invention, four swipe gestures may used by the user to select four tasks as follows, by way of example, navigation within lists, reading content, editing content, and audio control.

Navigation Within a List:

Information is managed as previously ordered lists or trees. Rightward swipe may enter a navigation within a list. The user may enter a list with a rightward swipe and navigate through the list with downward and upward swipes, by way of example.

Reading Content:

The same available touch gestures may be used to control reading of content and navigate between lines, paragraphs , headings and pages. Content may be shared and a keyword search may be performed in content being presented by using directional swipe gestures, a tap or double tap and/or a push to talk long hold.

Text Editor:

The text editor may be used for composing and editing text by performing speech-to-text conversion. Swipe gestures up, down, left, right may be used to navigate text being edited.

The same gestures may be used to enable text editing functions such as delete, insert, highlight and cut/paste. Alternatively or in addition, text editing functions may be performed with the assistance of speech input commands.

Audio Controller:

Swipe gestures up, down, left, and right may be used to control sound playback: play, stop, fast forward and reverse. Speech input commands may be similarly used.

According to features of the present invention, in addition to speech from loudspeaker 213 feedback to the user may be provided using tones or vibrations, i.e. haptic feedback, from vibrator 215.

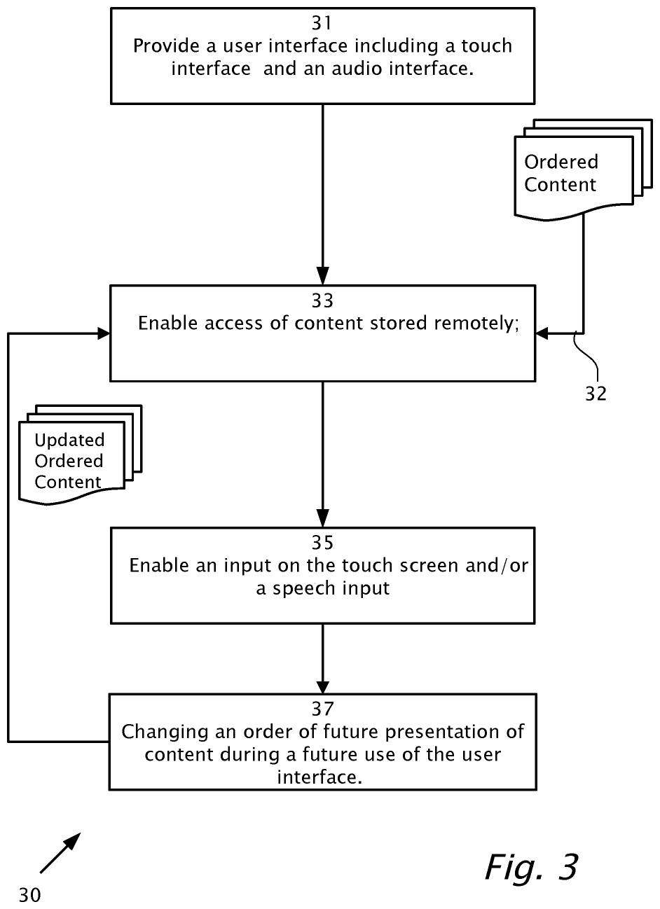

Reference is now made to FIG. 3, a flow diagram of a method according to an embodiment of the present invention. In step 31, a user interface is provided which includes a touch interface on touch screen 209 and an audio interface. Ordered content may be remotely provided (step 32). By way of example, an application programming interface (API) may be provided which enables accessibility (step 33) of remote stored content ordered in lists or trees to the client application. In order to access the ordered content, a visually impaired person is enabled to input (step 35) one or more gestures, as described above on touch screen 209. Similarly, the visually impaired person may input using a speech input, e.g. a voice command, during a long press, e.g. push to talk (PTT). Responsive to the user inputs, the client application or remote application installed on server 208 may update or change (step 37) the order of the content for a future use of the user interface.

The embodiments of the present invention may comprise a general-purpose or special-purpose computer system including various computer hardware components, which are discussed in greater detail below. Embodiments within the scope of the present invention also include computer-readable media for carrying or having computer-executable instructions, computer-readable instructions, or data structures stored thereon. Such computer-readable media may be any available media, transitory and/or non-transitory which is accessible by a general-purpose or special-purpose computer system. By way of example, and not limitation, such computer-readable media can comprise physical storage media such as RAM, ROM, EPROM, flash disk, CD-ROM or other optical disk storage, magnetic disk storage or other magnetic storage devices, or any other media which can be used to carry or store desired program code means in the form of computer-executable instructions, computer-readable instructions, or data structures and which may be accessed by a general-purpose or special-purpose computer system.

In this description and in the following claims, a “computer system” is defined as one or more software modules, one or more hardware modules, or combinations thereof, which work together to perform operations on electronic data. For example, the definition of computer system includes the hardware components of a personal computer, as well as software modules, such as the operating system of the personal computer. The physical layout of the modules is not important. A computer system may include one or more computers coupled via a computer network. Likewise, a computer system may include a single physical device (such as a smartphone, Personal Digital Assistant “PDA” and/or tablet) where internal modules (such as a memory and processor) work together to perform operations on electronic data. While any computer system may be mobile, the term “mobile computer system” especially includes laptop computers, net-book computers, tablets, cellular telephones, smart-phones, wireless telephones, personal digital assistants, portable computers with touch sensitive screens and the like.

In this description and in the following claims, a “network” is defined as any architecture where two or more computer systems may exchange data. The term “network” may include wide area network, Internet local area network, Intranet, wireless networks such as “Wi-fi”, virtual private networks, mobile access network using access point name (APN) and Internet. Exchanged data may be in the form of electrical signals that are meaningful to the two or more computer systems. When data is transferred or provided over a network or another communications connection (either hard wired, wireless, or a combination of hard wired or wireless) to a computer system or computer device, the connection is properly viewed as a computer-readable medium. Thus, any such connection is properly termed a computer-readable medium. Combinations of the above should also be included within the scope of computer-readable media. Computer-executable instructions comprise, for example, instructions and data which cause a general-purpose computer system or special-purpose computer system to perform a certain function or group of functions.

The term “server” as used herein, refers to a computer system including a processor, data storage and a network adapter generally configured to provide a service over the computer network. A computer system which receives a service provided by the server may be known as a “client” computer system.

The term “presentation” as used herein refers to presentation of content to a visually impaired user such as by audio presentation, ie. playing content on a loudspeaker. Presentation may also include tactile presentation such as using a dynamic electronic Braille device.

The term “reading” as used herein in the context of reading content refers to, a presentation such as by audio or Braille accessible by a visually impaired person.

The term “tap” as used herein refers to one or more taps such as a “double tap”.

The term “input on the touch screen” as used herein also includes an audio input initiated by an input on the touch screen, e.g. long press for push to talk.

The articles “a”, “an” is used herein, such as “a loudspeaker”, “a tap”, an “input” have the meaning of “one or more” that is “one or more loudspeakers”, “one or more taps” and “one or more inputs”.

The present application is gender neutral and personal pronouns ‘he’ and ‘she’ are used herein interchangeably.

All optional and preferred features and modifications of the described embodiments and dependent claims are usable in all aspects of the invention taught herein. Furthermore, the individual features of the dependent claims, as well as all optional and preferred features and modifications of the described embodiments are combinable and interchangeable with one another.

Although selected features of the present invention have been shown and described, it is to be understood the present invention is not limited to the described features. Instead, it is to be appreciated that changes may be made to these features, the scope of which is defined by the claims and the equivalents thereof.

The invention claimed is:

1. A method performable on a mobile computer system including a touch screen, a loudspeaker and a microphone, the method comprising:
providing a user interface including a touch interface enabled on the touch screen and an audio interface enabled on the loudspeaker and the microphone;
wherein remotely stored content is previously ordered in a list or tree;
enabling access to the previously ordered remotely stored content by playing the content on the loudspeaker using a plurality of inputs including a touch gesture on the touch screen and a speech input into the microphone;
responsive to the inputs on the touch screen and the speech input, presenting content by playing the content on the loudspeaker; and
in accordance with the inputs, changing an order of navigating the content within a list for a future use of the user interface.

2. The method of claim 1, wherein the touch input includes a directional swipe on the touch screen from a user.

3. The method of claim 2, wherein the directional swipe is selectably either upward, downward, leftward or rightward anywhere on the touch screen.

4. The method of claim 1, wherein the touch input includes a long press on the touch screen.

5. The method of claim 4, wherein the long press initiates and maintains the microphone operating for an audio input for the duration of the long press.

6. The method of claim 1, wherein the touch input includes a tap.

7. The method of claim 6, wherein the tap opens a context dependent previously defined set of options.

8. The method of claim 1, wherein a visually impaired user is enabled for input anywhere on the touch screen: a first input of a directional swipe selectably either upward, downward, leftward or rightward, a second input of a long press on the touch screen for press to talk and inputting a speech input and, a third input of the tap to open a context dependent previously defined set of options.

9. The method of claim 8, wherein the first input, the second input the third input and the audio input are collectively configured to perform all of: navigating through previously ordered content, reading content, composing test, editing text and playing audio.

10. A non-transitory computer-readable-medium having the software instructions stored therein to perform the method of claim 1.

11. A user interface comprising:
a touch interface enabled on a touch screen and an audio interface enabled on a loudspeaker and a microphone; the user interface configured to enable:
access of remotely stored content previously ordered in a list or tree, by playing the content on the loudspeaker, by using a plurality of inputs, including a touch gesture on the touch screen and a speech input into the microphone; and
presentation of the content by playing the content on the loudspeaker responsive to the inputs on the touch screen and the speech input and wherein, in accordance with the inputs, an order is changed for navigating the content for a future use of the user interface.

12. The user interface of claim 11, wherein the touch gesture includes a directional swipe on the touch screen from a user.

13. The user interface of claim 12, wherein the directional swipe is selectably either upward, downward, leftward or rightward anywhere on the touch screen.

14. The user interface of claim 11, wherein the touch gesture includes a long press on the touch screen.

15. The user interface of claim 14, wherein the long press initiates and maintains the microphone operating for a speech input for the duration of the long press.

16. The user interface of claim 11, wherein the touch gesture includes a tap on the touch screen.

17. The user interface of claim 16, wherein the tap on the touch screen opens a context dependent previously defined set of options.

18. The user interface of claim 11, wherein a visually impaired user is enabled for input anywhere on the touch screen: a first input of a directional swipe selectably either upward, downward, leftward or rightward, a second input of a long press on the touch screen for press to talk and, a third input of a tap to open a context dependent previously defined set of options.

19. The user interface of claim 18, wherein the first input, the second input and the third input are configured to perform all of: navigating through previously ordered content, reading content, composing text, editing text and playing audio.
